(19) United States
(12) Patent Application Publication
(10) Pub. No.: US 2013/0329328 A1
(43) Pub. Date: Dec. 12, 2013

(54) INTEGRATED PROTECTOR HAVING TWO PINS FOR CONTROLLING A BREAKOVER VOLTAGE TO PREVENT SURGE FROM A LIGHTING STRIKE AND STATIC ELECTRICITY

(71) Applicants: Robert Wang, Taoyuan County (TW); Michael Chen, Taoyuan County (TW); Ethan Huang, Taoyuan County (TW)

(72) Inventors: Robert Wang, Taoyuan County (TW); Michael Chen, Taoyuan County (TW); Ethan Huang, Taoyuan County (TW)

(73) Assignee: CERAMATE TECHNICAL (SUZHOU) CO., LTD., Suzhou New District (CN)

(21) Appl. No.: 13/490,437

(22) Filed: Jun. 6, 2012

(51) Int. Cl. H02H 3/22

(52) U.S. Cl. 361/91.5

(57) ABSTRACT

An integrated protector having two pins for controlling a breakover voltage to prevent surge from a lightning strike and static electricity comprises a thyristor with three electrodes, such as an SCR, a transistor for a gate of the thyristor to trigger signals, and a voltage detecting circuit. When static electricity or surge occurs at two ends of the integrated protector and the protected part/device that are arranged in a parallel connection, the integrated protector acquires a proper current to trigger the thyristor via the voltage detecting circuit. Accordingly, the integrated protector provides a route to guide the static electricity or the surge, which protects the part/device that is parallelly connected to the integrated protector.

### FIELD OF THE INVENTION

The present invention relates to a circuit protector, especially to an integrated protector having two pins for controlling a breakover voltage to prevent surge from a lightning strike and static electricity.

### DESCRIPTION OF THE RELATED ART

In order to prevent surge from a lightning strike and static electricity, a protecting component such as a thyristor or a variostor is parallelly connected between power sources or signal circuits. FIG. 1 shows a circuit diagram that a variostor 1 is utilized to protect a load device 200 in a circuit.

FIG. 2 shows a curve of voltage-current of the protecting component. When surge occurs, a breakover voltage V_{B0} of the protecting component has to be higher than a working voltage V_{DRM} of a protected electronic part or device and reaches a breakover current I_{B0} that is large enough. Invaded by the surge and the static electricity, the breakover voltages V_{B0} at two ends of the protected part increase proportionally to the soaring working voltage V_{DRM}. Accordingly, the protection is unideal, and the safety of the load device or using is influenced.

### SUMMARY OF THE INVENTION

The object of the present invention is to provide an integrated protector having two pins for controlling a breakover voltage to prevent surge from a lightning strike and static electricity. The integrated protector provides a route to guide the static electricity or the surge for protecting the part or the load device parallelly connected to the integrated protector.

A further object of the present invention is to provide an integrated protector having two pins for controlling a breaker voltage to prevent surge from a lightning strike and static electricity. The integrated protector is packed and includes two pins, thereby coupling and parallelly connecting to the part or the load device that is to be protected. A more convenient operation is achieved.

The integrated protector in accordance with the present invention comprises a thyristor with three electrodes, such as an SCR (Silicon-Controlled Rectifier); a transistor having an emitter connected to a first gate of the SCR, and a collector connected to a second anode of the SCR; and a voltage detecting circuit adopting a voltage dividing circuit with a first resistance and a second resistance; a base of the transistor being connected to one end of the first resistance and one end of the second resistance; the other end of the first resistance being connected to the second anode of the SCR, and the other end of the second resistance being connected to the second cathode of the SCR.

Further, when the SCR, the transistor, and the voltage detecting circuit are arranged on the same plate and packed, an integrated protector is achieved. Two pins are extended from two sides of the integrated protector, respectively, for achieving an external electrical connection.

The breakover voltage and the breakover current of the integrated protector are decided by the voltage detecting circuit installed in the integrated protector. Therefore, the voltage detecting circuit is able to control the breakover voltage and the breakover current, but the load device or the electronic part in the circuit is not influenced. Accordingly, the electronic part or the load device functions well under a normal voltage, and a good protection is accessible.

### BRIEF DESCRIPTION OF THE DRAWINGS

FIG. 1 is circuit diagram showing a conventional variostor executing a load protection;

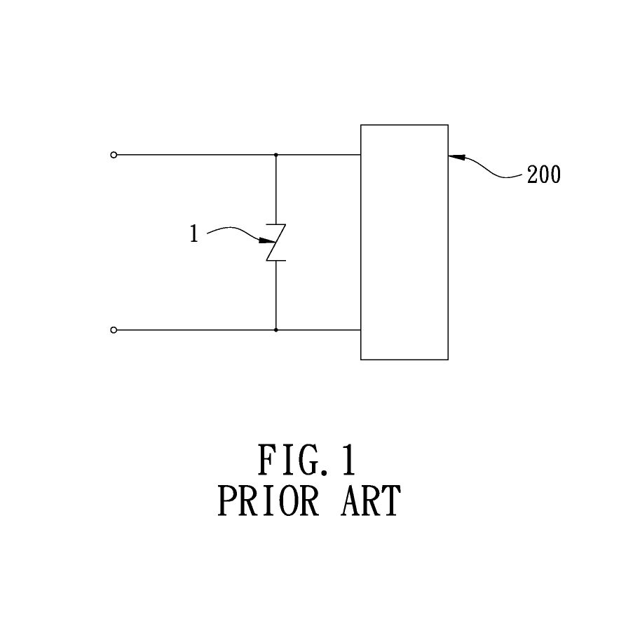

FIG. 2 is a voltage-current curve of a conventional protecting part;

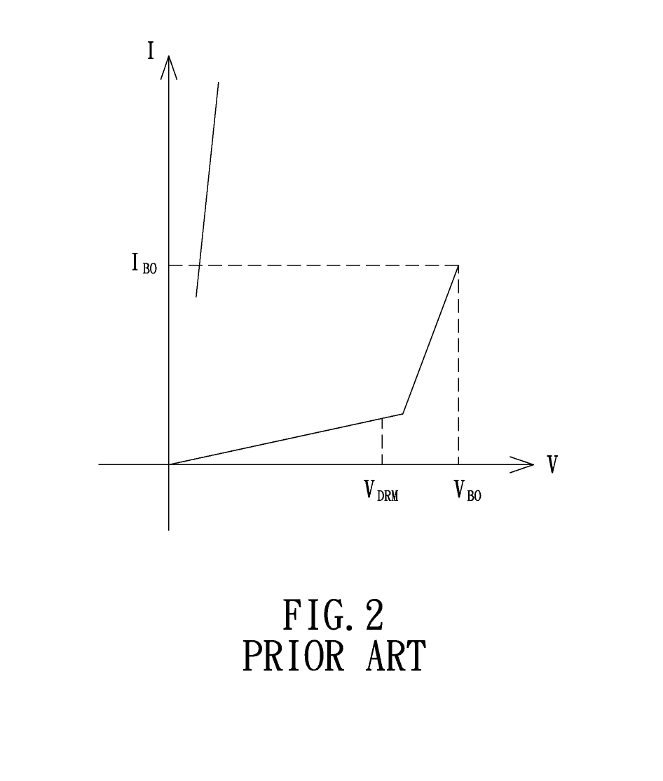

FIG. 3 is a circuit diagram of a first preferred embodiment of the present invention;

FIG. 4 is a schematic view showing the first preferred embodiment of the present invention packed with two pins;

FIG. 5 is a schematic view showing the first preferred embodiment of the present invention in use;

FIG. 6 is a circuit diagram of a coupled diode in the first preferred embodiment of the present invention;

FIG. 7 is a circuit diagram of a coupled Shockley Diode in the first preferred embodiment of the present invention;

FIG. 8 is a voltage-current curve of the first preferred embodiment of the present invention;

FIG. 9 is a schematic view showing the first preferred embodiment of the present invention coupled to a reverse integrated protector in a parallel connection;

FIG. 10 is a schematic view showing the first preferred embodiment of the present invention coupled to a reverse integrated protector in a series connection;

FIG. 11 circuit diagram of a second preferred embodiment of the present invention; and

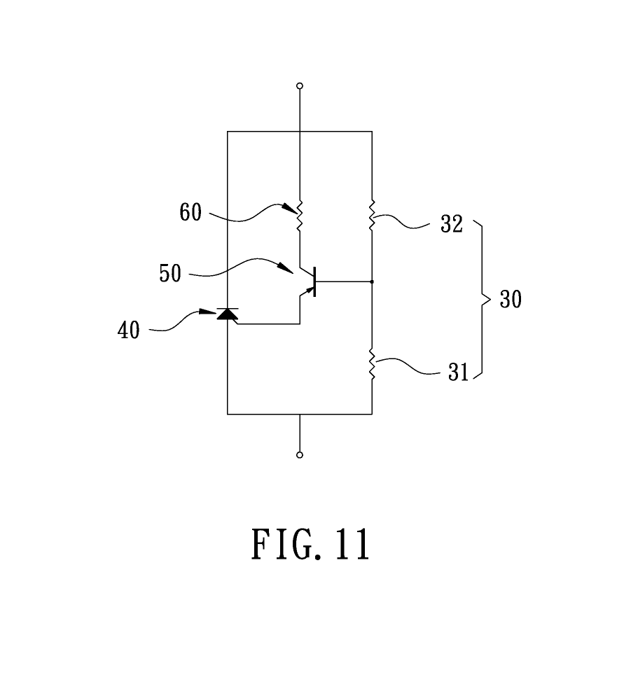

FIG. 12 is a schematic view of the second preferred embodiment of the present invention in using.

### DETAILED DESCRIPTION OF THE PREFERRED EMBODIMENTS

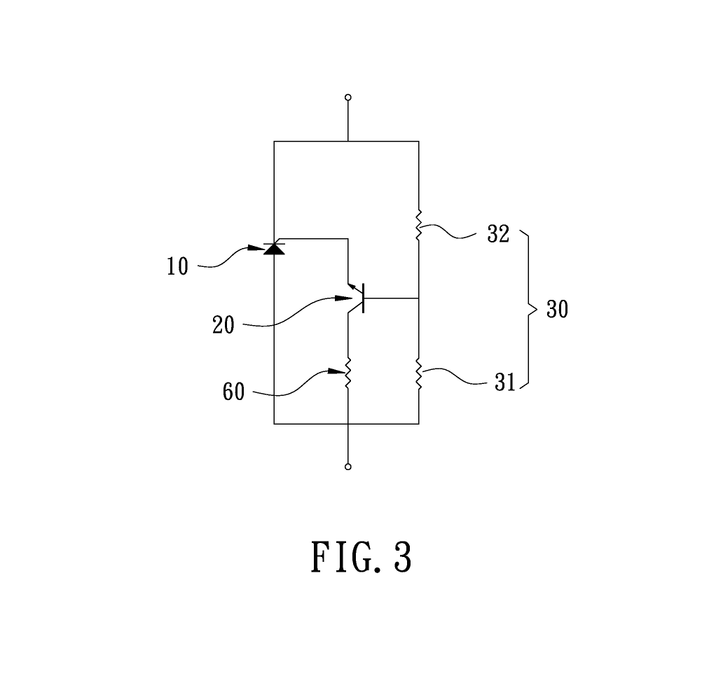

FIG. 3 shows a circuit diagram of a first preferred embodiment of the present invention. An integrated protector having two pins for controlling a breakover voltage to prevent surge from a lightning strike and static electricity is provided.

An SCR (Silicon-Controlled Rectifier) 10 adopts a thyristor with three electrodes.

A transistor 20 adopts an NPN transistor; an emitter of the transistor 20 is connected to a first gate of the SCR 10, and a collector of the transistor 20 is connected to a second anode of the SCR 10; a current limiting resistance 60 is disposed between the collector of the transistor 20 and the second anode of the SCR 10.

A voltage detecting circuit 30 adopts a voltage dividing circuit with a first resistance 31 and a second resistance 32; a base of the transistor 20 is connected to one end of the first resistance 31 and one end of the second resistance 32; the other end of the first resistance 31 is connected to the second anode of the SCR 10, and the other end of the second resistance 32 is connected to a second cathode of the SCR 10.

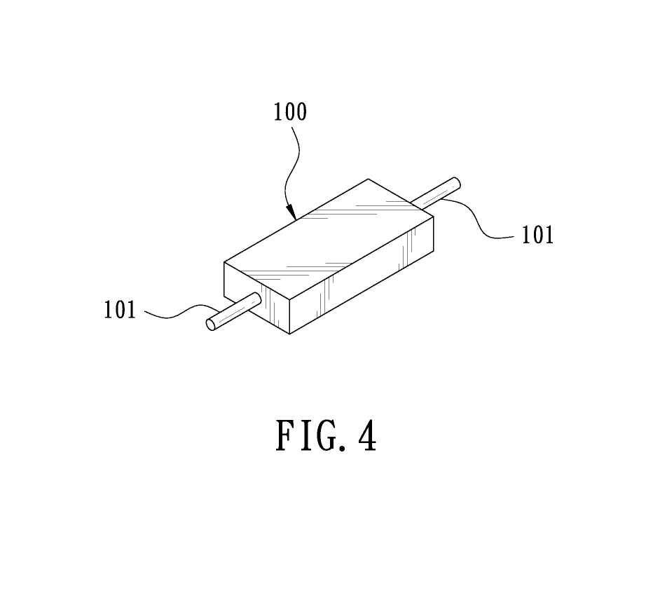

FIG. 4 shows a schematic view of the present invention packed with two pins. The SCR 10, the transistor 20, and the voltage detecting circuit 30 are arranged on a same plate for being packed, thereby contributing to an integrated protector 100. Two pins 101 are extended from two sides of the integrated protector 100, respectively, for achieving an external electrical connection.

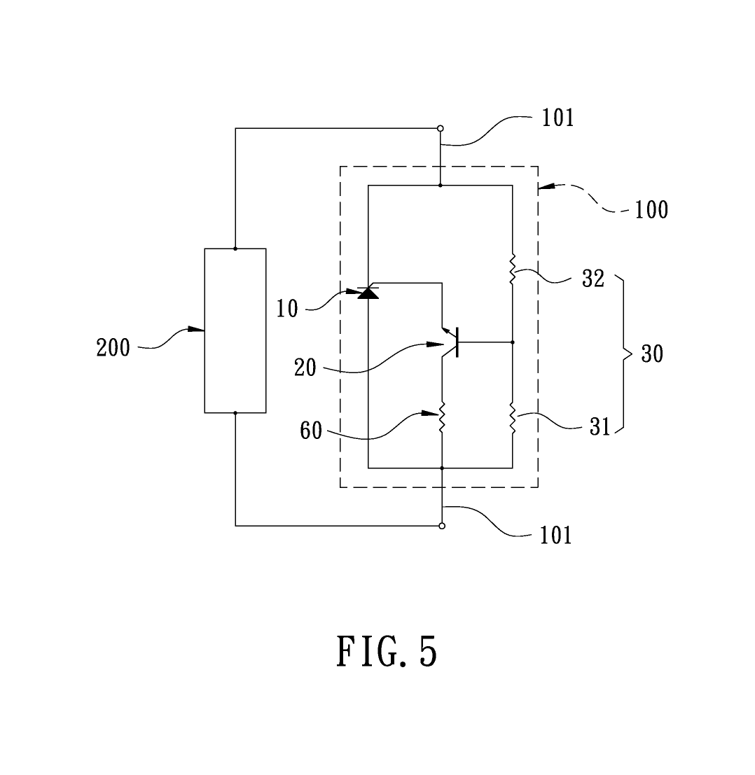

FIG. 5 shows a schematic view of afore preferred embodiment in using. The integrated protector 100 is coupled and parallelly connected to a load device 200 that is to be protected. When static electricity or surge occurs, the voltage between a first anode and a first cathode of the integrated protector 100 allows the base of the transistor 20 to generate current. Namely, the first gate of the SCR 10 could be triggered, and the SCR 10 starts breakover. When the current generated from surge or static electricity enters the SCR 10 through the second anode of the SCR 10, the current further flows out from the second cathode of the SCR 10. When the voltage dividing circuit formed by the first resistance 31 and the second resistance 32 is adopted, the breakover current of the SCR 10 is controllable in accordance with a practical need by adjusting the current of the emitter of the transistor 20.

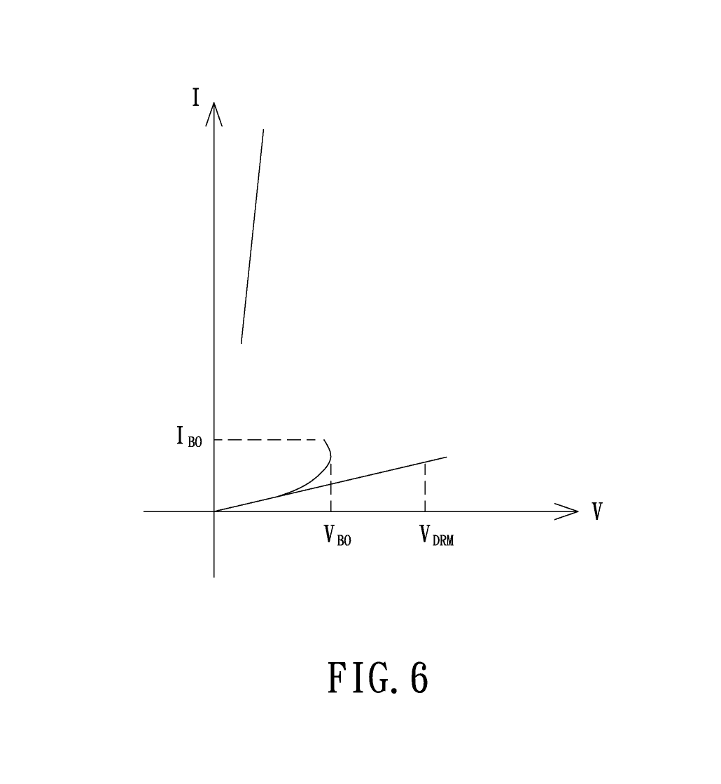

FIG. 6 shows a curve of voltage-current of afore preferred embodiment. When surge occurs, a breakover voltage V_{B0} of integrated protector is much lower than a working voltage V_{DRM}. Thereby, when invasion of the surge or the static electricity occurs, guidance is provided for achieving a favorable protection.

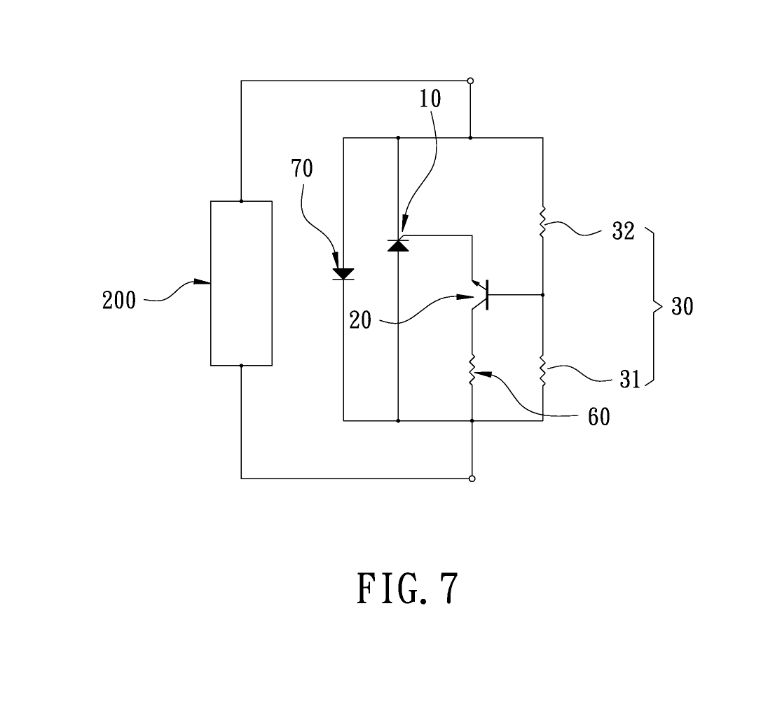

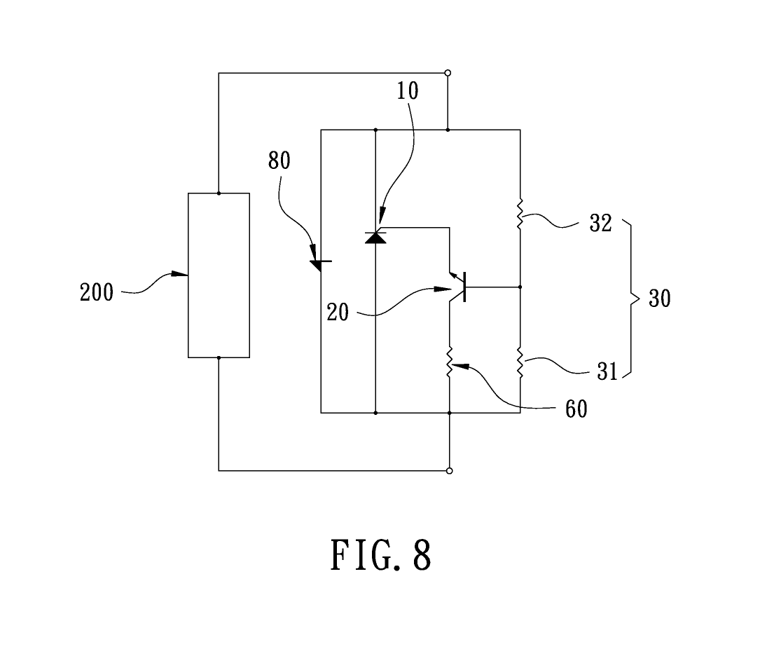

In order to prevent the load device 200 from breaking due to static electricity, electricity discharging, or reverse polarity, the SCR 10 is coupled to a reverse diode as shown in FIG. 7 of a circuit diagram of a coupled diode of the present invention. The SCR 10 is coupled to a reversed diode 70, so that a third anode of the diode 70 is connected to the second cathode of the SCR 10, and a third cathode of the diode 70 is connected to the second anode of the SCR 10. Accordingly, the diode 70 provides a reverse protection. Additionally, the SCR 10 of the present invention could be further coupled to a reversed Shockley Diode as shown in a circuit diagram in FIG. 8. When the SCR 10 is coupled to a reversed Shockley Diode 80, a fourth anode of the Shockley Diode 80 is connected to the second cathode of the SCR 10, and a fourth cathode of the Shockley Diode 80 is connected to the second anode of the SCR 10. Thereby, a similar reverse protection is provided.

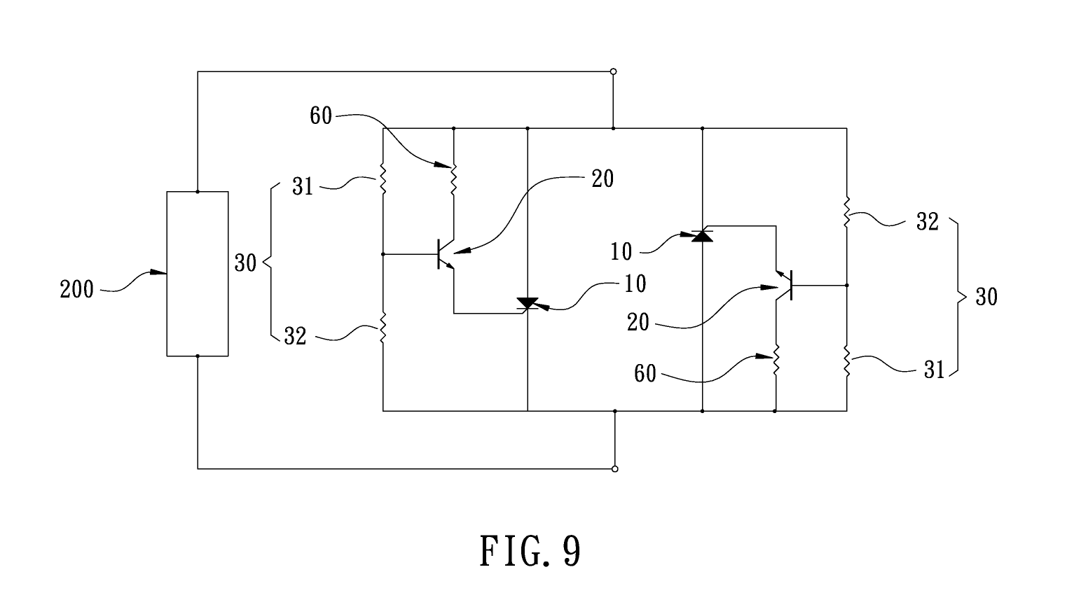

FIG. 9 shows the first preferred embodiment coupled to a reversed integrated protector. Wherein, when the integrated protector is parallelly connected to a reversed integrated protector and thence coupled to the load device 200 parallelly, the load device 200 that adopts an alternating current is protected from a two-way surge.

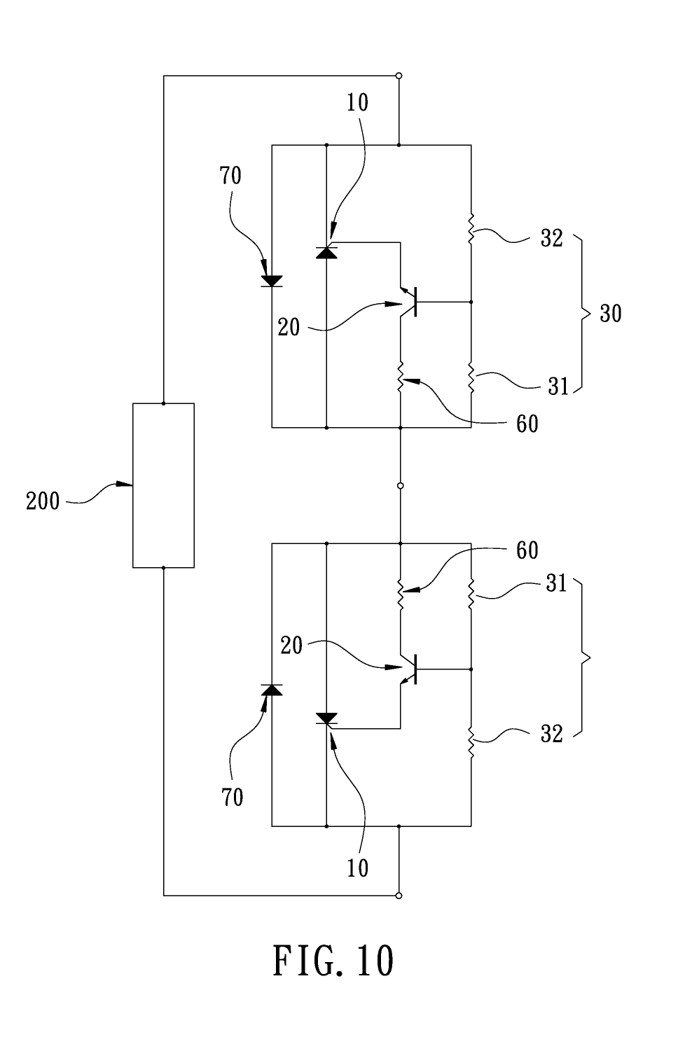

FIG. 10 shows the first preferred embodiment coupled to a reversed integrated protector. Wherein, when the integrated protector is coupled to a reversed diode 70 and thence reversely and serially connected to another integrated protector with another reverse diode 70, the combination is further coupled to the load device 200, so that the load device 200 that adopts an alternating current is protected from a two-way surge.

FIG. 8 shows a further circuit diagram of a second preferred embodiment of the present invention that discloses an integrated protector having two pins for controlling a breakover voltage to prevent surge from a lightning strike and static electricity.

A PUT 40 (Programmable Uni-junction Transistor) adopts a thyristor with three electrodes.

A transistor 50 adopts a PNP transistor; an emitter of the transistor 50 is connected to a second gate of the PUT 40, and a collector of the transistor 50 is connected to a fifth cathode of the PUT 40; a current limiting resistance 60 is disposed between the collector of the transistor 50 and a fifth anode of the PUT 40.

A voltage detecting circuit 30 adopts a voltage dividing circuit with a first resistance 31 and a second resistance 32; a base of the transistor 50 is connected to one end of the first resistance 31 and one end of the second resistance 32; the other end of the first resistance 31 is connected to the fifth anode of the PUT 40, and the other end of the second resistance 32 is connected to the fifth cathode of the PUT 40.

Wherein, the PUT 40, the transistor 50, and the voltage detecting circuit 30 can be arranged on a same plate for being packed in accordance with practical needs, thereby contributing to an integrated protector.

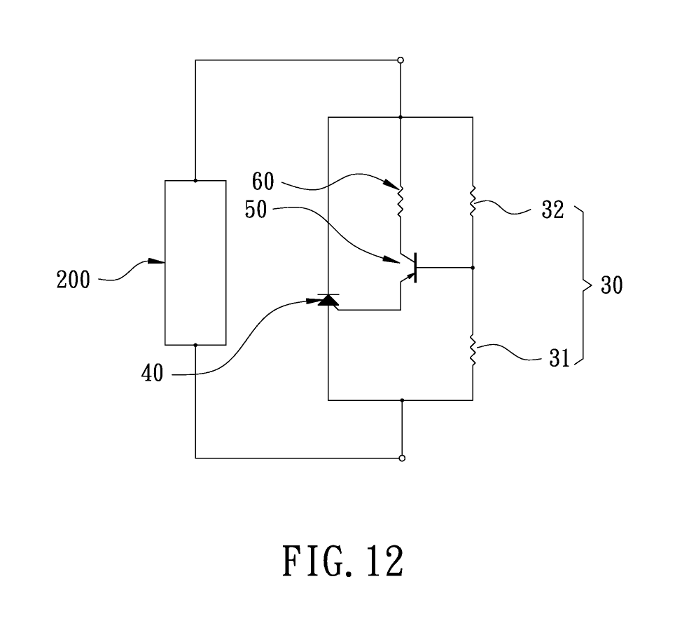

FIG. 12 shows afore preferred embodiment in using. Wherein, the integrated protector of the present invention is parallelly connected to a load device 200 that is to be protected. When the surge from the lightning strike or the static electricity occurs, the voltage between the first anode and the first cathode of the integrated protector allows the base of the transistor 50 to provide a proper current. Whereby, the emitter of the transistor 50 generates sufficient current to trigger the second gate of the PUT 40. Accordingly, the PUT 40 starts breakover. When the current generated from surge or static electricity enters the PUT 40 through the fifth anode of the PUT 40, the current further flows out from the fifth cathode of the PUT 40. The dividing circuit formed by the first resistance 31 and the second resistance 32 can adjust the current of the emitter of the transistor 50 in accordance with practical needs, so that the breakover current of the PUT 40 is controllable.

The present invention has advantageous as follows:

1. The integrated protector of the present invention acquires a proper current via the voltage detecting circuit so as to trigger the thyristor SCR or PUT when the surge from the lightning strike or the static electricity occurs. Accordingly, the integrated protector provides a route to guide the surge or the static electricity. Whereby, the electronic part or the load device parallelly connected to the integrated protector is protected.

2. Packed into an integrated protector with two pins, the integrated protector of the present invention can conveniently coupled and parallelly connected to the electronic part or the load device for achieving a handy operation.

3. The integrated protector of the present invention adjusts the first resistance and the second resistance in the voltage detecting circuit to control the breakover voltage. Thereby, when the surge or the static electricity occurs, the breakover voltage that is much lower than the working voltage provides guidance for achieving good protection.

I claim:

1. An integrated protector having two pins for controlling a breakover voltage to prevent surge from a lightning strike and static electricity comprising:
an SCR (Silicon-Controlled Rectifier) adopting a thyristor with three electrodes;
a transistor adopting an NPN transistor; an emitter of said transistor being connected to a first gate of said SCR, and a collector of said transistor being connected to a second anode of said SCR; and
a voltage detecting circuit adopting a voltage dividing circuit with a first resistance and a second resistance in series connection; a base of said transistor being connected to one end of said first resistance and one end of said second resistance; the other end of said first resistance being connected to a second anode of said SCR, and the other end of said second resistance being connected to said second cathode of said SCR.

2. The integrated protector as claimed in claim 1, wherein, said SCR, said transistor, and said voltage detecting circuit are arranged on a same plate for being packed, thereby contributing to an integrated protector; two pins are extended from two sides of said integrated protector, respectively, which are electrically connected to a protected component or device.

3. The integrated protector as claimed in claim 1, wherein, said integrated protector is parallelly connected to a reversed integrated protector so as to prevent a two-way surge.

4. The integrated protector as claimed in claim 1, wherein, said integrated protector is serially connected to a reversed integrated protector so as to prevent a two-way surge.

5. The integrated protector as claimed in claim 1, wherein, a current limiting resistance is disposed between said collector of said transistor and said second anode of said SCR.

6. The integrated protector as claimed in claim 1, wherein, said SCR is coupled to a reversed diode.

7. The integrated protector as claimed in claim 1, wherein, said SCR is coupled to a Shockley diode.

8. An integrated protector having two pins for controlling a breaker voltage to prevent surge from a lightning strike and static electricity comprising:
a PUT (Programmable Uni-junction Transistor) adopting a thyristor with three electrodes;
a transistor adopting a PNP transistor; an emitter of said transistor being connected to a second gate of said PUT, and a collector of said transistor being connected to a fifth anode of said PUT; and
a voltage detecting circuit adopting a voltage dividing circuit with a first resistance and a second resistance in series connection; a base of said transistor being connected to one end of said first resistance and one end of said second resistance; the other end of said first resistance being connected to said fifth anode of said PUT, and the other end of said second resistance being connected to a fifth cathode of said PUT.

9. The integrated protector as claimed in claim 8, wherein, a current limiting resistance is disposed between said collector of said transistor and said fifth anode of said PUT.
